(19) United States
(12) Patent Application Publication
(10) Pub. No.: US 2009/0155455 A1
(43) Pub. Date: Jun. 18, 2009

(54) System And Method For Protecting Electronic Device Display Screen

(76) Inventor: Robert Paul Landis, Baltimore, OH (US)

Correspondence Address: RONALD J. KOCH, 698 MORRISON RD., SUITE B, COLUMBUS, OH, 43213, US

(21) Appl. No.: 11/956,705

(22) Filed: Dec. 14, 2007

(51) Int. Cl. B05D 5/00

(52) U.S. Cl. 427/64; 118/264

(57) ABSTRACT

A system and method for protecting an electronic device display screen comprises an electronic device 1 having a display screen 3, finger nail polish 4, and finger nail polish applicator 2. Finger nail polish 4 is applied to the display screen 3 using the finger nail polish applicator 2.

### CROSS REFERENCE TO RELATED APPLICATIONS

Not Applicable

### FEDERALLY SPONSORED RESEARCH

Not Applicable

### SEQUENCE LISTING, TABLE, OR COMPUTER PROGRAM COMPACT DISK APPENDIX

Not Applicable

### CLAIM OF PRIORITY BASED ON COPENDING APPLICATION

Not Applicable

### BACKGROUND

The present invention relates generally to protecting the display screens (i.e. “screen”) of electronic devices and specifically to protecting screens of communication devices including cell phones. Conventional systems (FIG. 3) for protecting the screens 11 of electronic devices 10 comprise thin, transparent, flexible sheets 12 having adhesive material on one side. In use, the sheets are applied to the screen and can thereafter be removed by peeling.

One known system is known as “WriteRight” (trademark), sold by “Fellows, Inc.” (trademark), www.fellowes.com. These systems are problematic in that the protectors can easily be torn away, are thin and thus minimally protective, and wear out easily. Additionally, air bubbles or pockets form under the layer.

The present invention overcomes these problems as well as achieving other objects and advantageous apparent to those in the art.

### SUMMARY

A method for protecting the display screen of an electronic device comprises the steps of providing, an electronic device having a display screen, finger nail polish, a finger nail polish applicator, and applying the finger nail polish to the display screen using the finger nail polish applicator.

Generally, finger nail polish is provided for sale along with an applicator. It is contemplated by the inventor that the associated applicator be used. However, other brushes, rags, or cloths, may be used provided the function is not compromised. In addition, the polish may be applied using a sponge.

It is preferred that the polish be applied in an evenly distributed layer on the display screen. However, this is not essential, only preferred. In addition, layers of varying thickness may be employed to suit different applications (thicker layers for harsh environments, etc.).

Another advantage of the present invention is that when applied to a screen having scratches, the scratches are less visible, and a smoother surface is attained. Morever, the scratched area is made stronger.

The term “electronic device” as used, comprises cell phones and communication devices. As will be apparent, there are myriad electronic devices having display screens and the present invention can be used with many of them.

Finger nail polish remover can be used to remove the finger nail polish from the screen. An applicator is used to apply the remover. The applicator function can be accomplished with a brush, rag, “Q tips” (trademark)—or the like, or any other method provided the function of applying remover can be achieved. The remover can also be sprayed or splashed onto the surface. The screen can thereafter be re-coated with new finger nail polish and the process repeated.

### BRIEF DESCRIPTION OF THE DRAWINGS

FIG. 1 depicts a perspective, fragmentary view of the invention

FIG. 2 depicts a perspective, fragmentary view of the invention

FIG. 3 depicts a perspective, fragmentary view of the prior art

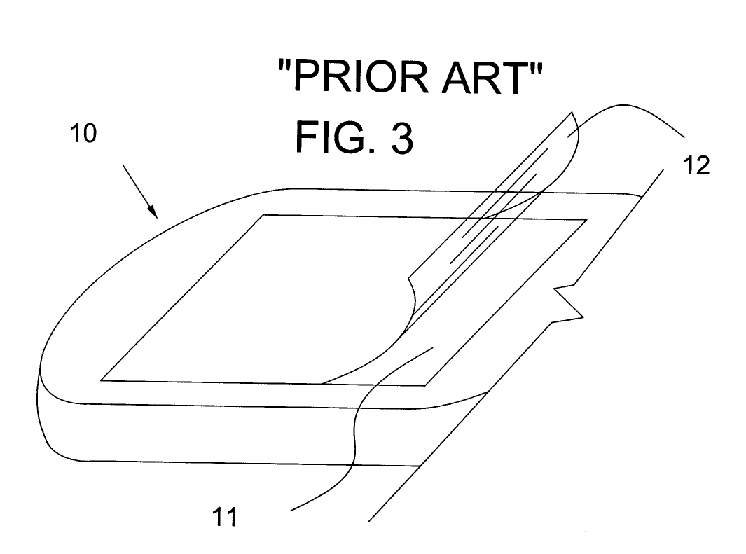

### DETAILED DESCRIPTION

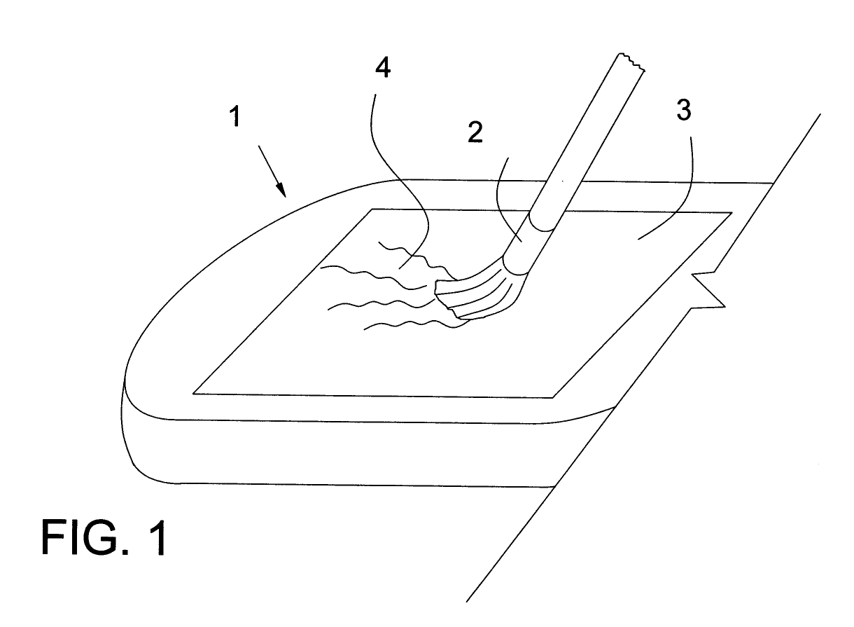

FIG. 1 depicts a preferred embodiment of the present invention comprising an electronic device 1 having a display screen 3, finger nail polish 4, and a finger nail polish applicator 2. Finger nail polish 4 is applied to the display screen 3 using the finger nail polish applicator 2.

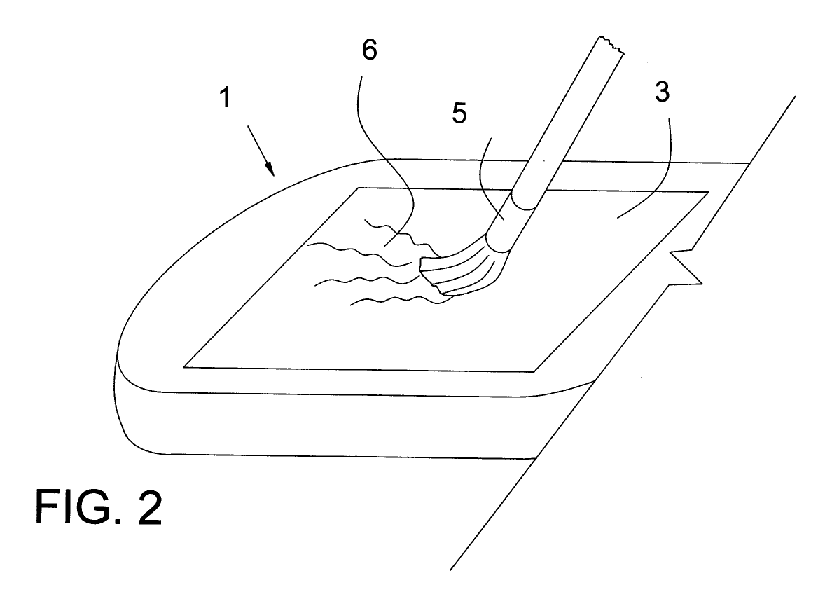

FIGS. 1 and 2 in combination depict a preferred embodiment of the present invention wherein there is further provided finger nail polish remover 6 and finger nail polish remover applicator 5. The applicator 5 is used to apply the remover 6 to the display screen 3 (having previously applied thereto finger nail polish 4).

What is claimed is:

1. A method for protecting the display screen of an electronic device comprising:
applying finger nail polish to the display screen of an electronic device;
whereby finger nail polish may be used to protect said display screen.

2. The method of claim 1 further comprising:
applying finger nail polish remover to said display screen;
whereby finger nail polish may be removed from said display screen.

3. A method for protecting the display screen of an electronic device comprising the steps of:
providing,
an electronic device having a display screen,
finger nail polish,
a finger nail polish applicator;
applying said finger nail polish to said display screen using said finger nail polish applicator.

4. The method of claim 3 further comprising:
said electronic device comprising a cell phone.

5. The method of claim 3 further comprising:
said electronic device comprising a communication device.

6. The method of claim 3 further comprising the steps of:
providing finger nail polish remover;
using said finger nail polish remover to remove said finger nail polish from said display screen.

7. The method of claim 6 further comprising the steps of:
providing an applicator for applying said finger nail polish remover;
using said applicator to apply said finger nail polish remover to said display screen;
whereby said finger nail polish may be removed from said display screen.

8. A system for protecting the display screen of an electronic device comprising:
an electronic device having a display screen;
finger nail polish;
a finger nail polish applicator;
whereby said finger nail polish may be applied to said screen using said applicator.

9. The system of claim 8 further comprising:
said electronic device comprising a cell phone.

10. The system of claim 8 further comprising:
said electronic device comprising a communication device.

11. The system of claim 8 further comprising:
finger nail polish remover;
whereby said finger nail polish remover may be used to remove said finger nail polish from said display screen.
